(19) United States
(12) Patent Application Publication
(10) Pub. No.: US 2016/0088706 A1
(43) Pub. Date: Mar. 24, 2016

(54) DETECTION DEVICE, DETECTION METHOD, AND RECORDING MEDIUM STORING A DETECTION PROGRAM

(71) Applicants: Osamu Kizaki, Saitama (JP); Nobuhiro Morita, Tokyo (JP); Yuji Ohue, Kanagawa (JP); Akiyoshi Nakai, Kanagawa (JP); Kenta Yamaguchi, Kanagawa (JP); Toshihiro Isozaki, Kanagawa (JP)

(72) Inventors: Osamu Kizaki, Saitama (JP); Nobuhiro Morita, Tokyo (JP); Yuji Ohue, Kanagawa (JP); Akiyoshi Nakai, Kanagawa (JP); Kenta Yamaguchi, Kanagawa (JP); Toshihiro Isozaki, Kanagawa (JP)

(21) Appl. No.: 14/856,820

(22) Filed: Sep. 17, 2015

(30) Foreign Application Priority Data
Sep. 19, 2014 (JP) 2014-191107
Sep. 10, 2015 (JP) 2015-178265

(51) Int. Cl. H05B 33/08; H05B 37/02

(52) U.S. Cl. CPC H05B 33/0854; H05B 37/0227; H05B 37/0272

(57) ABSTRACT

A detection device includes a detection unit that detect a temperature at each of multiple areas in a predetermined space where the detection device is provided, a determination unit that determines whether the detected temperature at each of the multiple areas is within a predetermined range to generate a first determination result, a generator that generates heat source data indicating that a heat source exists at a specific area of the multiple areas, when the first determination result indicates that the specific area has the detected temperature that is within the predetermined range, and a transmitter that transmits the heat source data indicating that the heat source exists at the specific area to a management system, wherein the management system controls one or more control target devices provided on the specific area of the predetermined space using the heat source data.

### CROSS-REFERENCE TO RELATED APPLICATION

This patent application is based on and claims priority pursuant to 35 U.S.C. §119(a) to Japanese Patent Application Nos. 2014-191107, filed on Sep. 19, 2014 and 2015-178265, filed on Sep. 10, 2015 in the Japan Patent Office, the entire disclosures of which are hereby incorporated by reference herein.

### BACKGROUND

1. Technical Field

The present invention relates to a detection device, a detection method, and a non-transitory recording medium storing a detection program.

2. Background Art

In partitioning space such as an office into multiple areas, some areas are occupied by human while other areas are not occupied by human. In occupied areas, it is desired to turn on a lighting apparatus for increased productivity. By contrast, it is not necessary to turn on lighting apparatuses in unoccupied areas, or even preferable to turn off lighting apparatuses to reduce waste of electric power. A technology that detects presence of human using a temperature distribution sensor with a thermopile and saves energy by turning off lighting apparatuses in unoccupied areas is known.

### SUMMARY

An example embodiment of the present invention provides a novel detection device that includes a detection unit that detect a temperature at each of multiple areas in a predetermined space where the detection device is provided, a determination unit that determines whether the detected temperature at each of the multiple areas is within a predetermined range to generate a first determination result, a generator that generates heat source data indicating that a heat source exists at a specific area of the multiple areas, when the first determination result indicates that the specific area has the detected temperature that is within the predetermined range, and a transmitter that transmits the heat source data indicating that the heat source exists at the specific area to a management system, wherein the management system controls one or more control target devices provided on the specific area of the predetermined space using the heat source data.

Further example embodiments of the present invention provide a detection method and a non-transitory recording medium storing a detection program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a schematic diagram illustrating a configuration of a position management system as an embodiment of the present invention.

FIG. 2 is a diagram illustrating a LED lighting apparatus as an example of a device to be controlled as an embodiment of the present invention.

FIG. 3 is a diagram illustrating a hardware configuration of a detection device as an embodiment of the present invention.

FIG. 4 is a diagram illustrating a hardware configuration of a position information management system as an embodiment of the present invention.

FIG. 5 is a diagram illustrating a functional configuration of the position management system of FIG. 1 as an embodiment of the present invention.

FIG. 6A is a conceptual diagram illustrating layout information of a control target device, and FIG. 6B is a conceptual diagram illustrating layout information of an office room.

FIG. 7 is a conceptual diagram illustrating a control rule management table as an embodiment of the present invention.

FIG. 8 is a sequence diagram illustrating operation performed by the position management system as an embodiment of the present invention.

FIG. 9A is a conceptual diagram illustrating temperature distribution, and FIG. 9B is a diagram illustrating heat source data that indicates whether a heat source exists.

FIG. 10 is a diagram illustrating heat source data that indicates whether a heat source exists for all areas in an office room.

FIG. 11 is a flowchart illustrating operation of generating heat source data as an embodiment of the present invention.

FIG. 12A is a conceptual diagram illustrating temperature distribution, and FIG. 12B is a diagram illustrating heat source data that indicates whether a heat source exists.

FIG. 13 is a flowchart illustrating operation of generating heat source data as another embodiment of the present invention.

FIG. 14A is a conceptual diagram illustrating temperature distribution, and FIG. 14B is a diagram illustrating heat source data that indicates whether a heat source exists.

FIGS. 15A and 15B are graphs illustrating temperature change in a specific area.

FIG. 16 is a flowchart illustrating operation of generating heat source data as yet another embodiment of the present invention.

FIG. 17A is a conceptual diagram illustrating temperature distribution, and FIG. 17B is a diagram illustrating heat source data that indicates whether a heat source exists.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

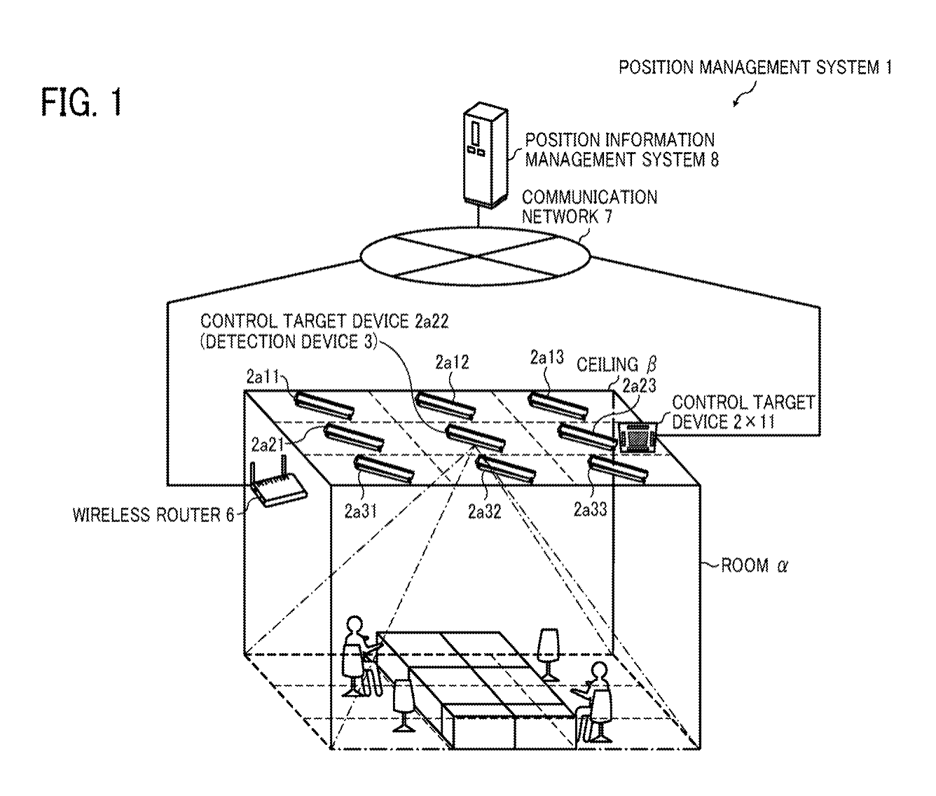

Referring to FIGS. 1 to 10, an embodiment of the present invention is described.

FIG. 1 is a schematic block diagram illustrating a configuration of a position management system according to the embodiment. As illustrated in FIG. 1, a position management system 1 in this embodiment includes multiple control target devices 2a11, 2a12, 2a13, 2a21, 2a22, 2a23, 2a31, 2a32, and 2a33, a control target device 2x11, a wireless router 6, and a position information management system 8, which are connected through a communication network 7. The control target devices 2a11, 2a12, 2a13, 2a21, 2a22, 2a23, 2a31, 2a32, and 2a33 are each disposed on a part of the ceiling β of an office room α, which is an example of a predetermined space.

In this embodiment, the part of the ceiling area is divided into nine areas. The control target devices 2a11, 2a12, 2a13, 2a21, 2a22, 2a23, 2a31, 2a32, and 2a33 are respectively located in the nine-partitioned areas of the part on the ceiling β. The control target device 2a22 in the center area includes a detection device 3. It should be noted that any one of the control target devices 2a11, 2a12, 2a13, 2a21, 2a22, 2a23, 2a31, 2a32, and 2a33 is referred to as “a control target device 2a” hereinafter. Further, in this example, one area corresponds to a square whose dimensions are 70 cm×70 cm.

The control target device 2a is a fluorescent-shaped light emitting diode (LED) lighting apparatus. The detection device in the control target device 2a22, which is provided with a thermopile, detects temperature distribution of the office room α that is partitioned into multiple areas (i.e., nine areas), and wirelessly transfers heat source data indicating whether the heat source exists in each area. The control target device 2x11 is an air-conditioner.

The wireless router 6 transfers the heat source data transferred from the detection device 3 to the position information management system 8 via the communication network 7. The communication network 7 may be implemented by a local area network (LAN), which may include the Internet.

The position information management system 8 generates control data for controlling the control target devices 2a and 2x, respectively, based on at least the heat source data transferred by the wireless router 6, and transfers the control data to the control target devices 2a and 2x, respectively. The control target device 2a controls a light level of the LED based on the control data. The control target device 2x11 controls temperature, humidity, air flow power, or air flow direction based on the control data. The control target device 2a22 not only detects the temperature distribution in the office room α with the detection device 3, but also controls the light level of the LED of its own based on the control data.

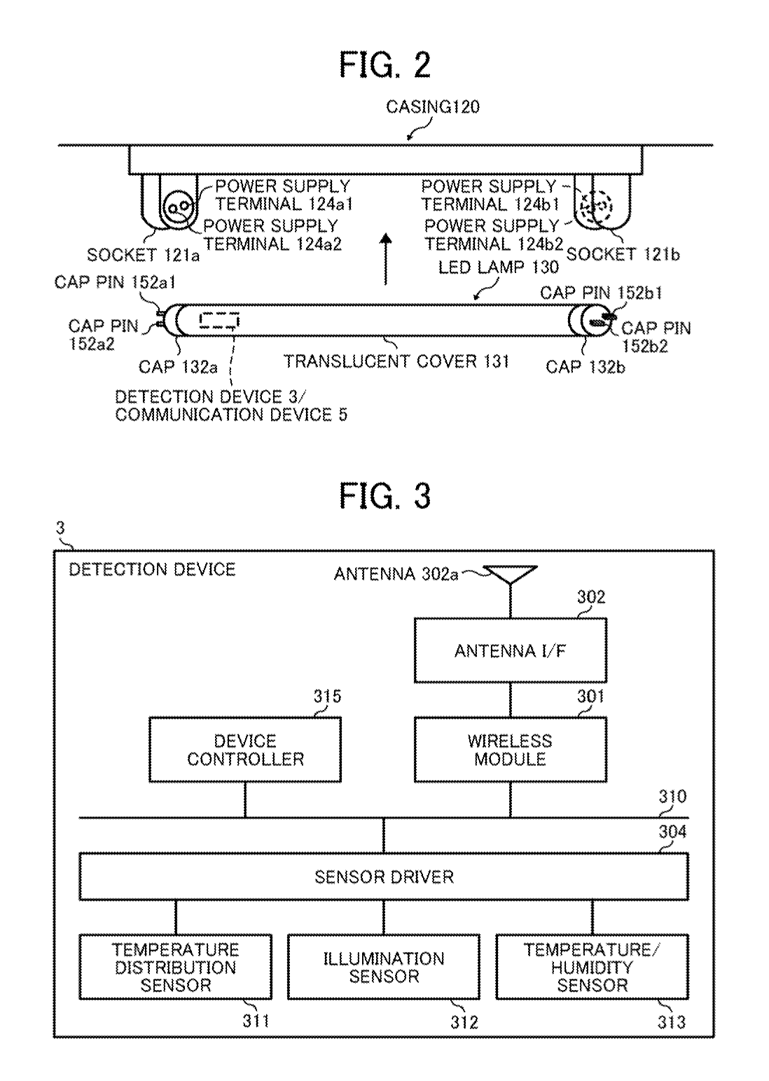

Next, a configuration of the control target device 2a and a casing on which the control target device 2a is mounted are described below with reference to FIG. 2. FIG. 2 illustrates an outer appearance of the control target device 2a, when the control target device 2a is implemented by the fluorescent LED lighting device according to an example embodiment of the present invention.

<Configuration of Control Target Device>

As illustrated in FIG. 2, the control target device 2a22 as the florescent LED lighting device is a straight tube lamp 130, and can be mounted on a casing 120 having a surface attached around the center of the ceiling β in the office room α in FIG. 1. The casing 120 has a socket 121a and a socket 121b at the respective ends. The socket 121a includes two power supply terminals 124a1 and 124a2, each of which supplies electric power to the LED lamp 130 when the LED lamp 130 is housed in the casing 120. The socket 121b includes two power supply terminals 124b1 and 124b2, each of which supplies electric power to the LED lamp 130 when the LED lamp 130 is housed in the casing 120. With these sockets, the casing 120 supplies electric power from a power supply to the LED lamp 130.

The LED lamp 130 includes a translucent cover 131, caps 132a and 132b that are provided at the respective ends of the translucent cover 131, and the detection device 3 placed inside the translucent cover 131. The translucent cover 131 may be made of, for example, resin material such as acrylic resin. The translucent cover 131 covers a light source, such as a LED module provided inside.

The cap 132a has cap pins 152a1 and 152a2, which are respectively connected to the power supply terminals 124a1 and 124a2 of the socket 121a. The cap 132b has cap pins 152b1 and 152b2, which are respectively connected to the power supply terminals 124b1 and 124b2 of the socket 121b. As the LED lamp 130 is housed inside the casing 120, electric power is supplied to each of the cap pins 152a1, 152a2, 152b1, and 152b2, via the power supply terminals 124a1, 124a2, 124b1, and 124b2 of the casing 120. The LED lamp 130 emits light outside through the translucent cover 131. The detection device 3 is operated with electric power supplied from the casing 120.

<Hardware Configuration of Position Management System>

Hardware configurations of the detection device 3 and the position information management system 8 are described below.

<Hardware Configuration of Detection Device>

The hardware configuration of the detection device 3 is described below with reference to FIG. 3. FIG. 3 is a schematic block diagram illustrating the hardware configuration of the detection device 3 as an embodiment of the present invention. The detection device 3 includes a wireless module 301, an antenna I/F 302, an antenna 302a, a sensor driver 304, a temperature distribution sensor 311, an illumination sensor 312, a temperature/humidity sensor 313, and a device controller 315, which are electrically connected through a bus line 310 such as an address bus or a data bus.

Among these components, the wireless module 301 communicates with one or more external apparatuses wirelessly via the antenna I/F 302 and the antenna 302a, in compliance with any desired communications protocol based on such as Bluetooth, Wi-Fi, or ZigBee standard. The communications protocol may not only be based on wireless communication but also based on wired communication using Ethernet or Power Line Communications (PLC). The wireless module 301 may operate under control of a communication control program.

The temperature distribution sensor 311 is, for example, a themopile sensor that detects temperature distribution in the office room α using infrared radiation.

The illumination sensor 312 detects brightness in the office room α. The temperature/humidity sensor 313 detects temperature and humidity in the office room α.

The sensor driver 304 drives the temperature distribution sensor 311, the illumination sensor 312, and the temperature/humidity sensor 313. The sensor driver 304 further generates heat source data that indicates whether or not a heat source exists based on the temperature distribution data output by the temperature distribution sensor 311. It should be noted that the sensor driver 304 can implement its function using software.

The device controller 315 controls operation of the control target device. When located inside the control target device 2, the device controller 315 may be implemented by a circuit that controls the light level of the LED. When located inside the control target device 2x11, the device controller 315 may be implemented by a circuit that controls air flow of the control target device 2X11 serving as the air conditioner. The circuit in this embodiment includes any programmed processor that operates under control of software, such as a detection control program stored in a memory such as a RAM.

For the control target device 2a other than the control target device 2a22, the control target device 2a includes the wireless module 301, the antenna I/F 302, the antenna 302a, the bus line 310, and the device controller 315 among the configuration in FIG. 3. The control target device 2a other than the control target device 2a22 includes a communication device 5 capable of communicating with the position information management system 8.

<Hardware Configuration of Position Information Management System>

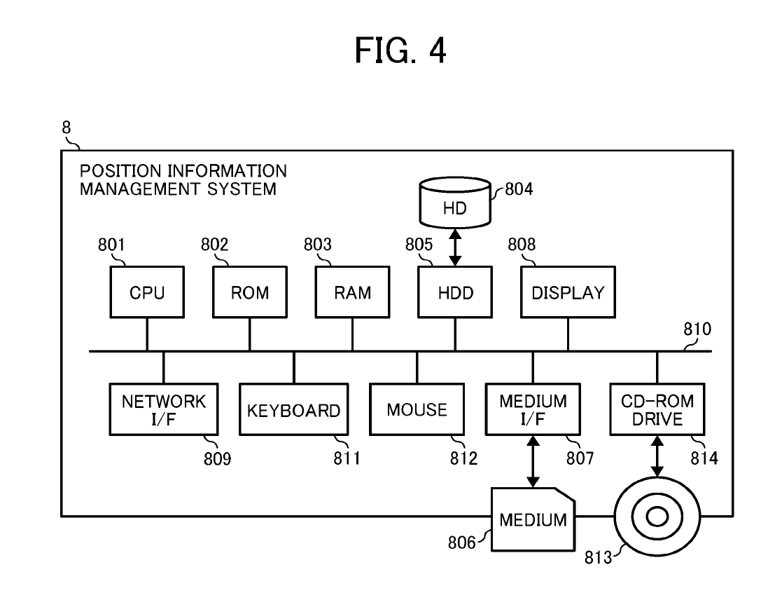

Next, a hardware configuration of the position information management system 8 is described below. FIG. 4 is a schematic block diagram illustrating a hardware configuration of the position information management system 8 in this embodiment.

The position information management system 8, in this example, is implemented by at least one computer. The position information management system 8 includes a CPU 801 that controls entire operation of the position information management system 8, a ROM 802 that stores a program such as an Initial Program Loader (IPL) used for driving the CPU 801, a RAM 803 that is used as a work area for the CPU 801, a hard disk (HD) 804 that stores various data such as a position information management program, a hard disk drive (HDD) 805 that controls reading/writing of various data from/to the HD 804 under control of the CPU 801, a medium I/F 807 that controls reading/writing data from/to a recording medium 806 such as a flash memory, a display 808 that displays various information such as a cursor, menu, window, text, and/or image, a network I/F 809 that allows communication of data using the communication network 7, a keyboard 811 that includes multiple keys for inputting texts, numeric values, or various commands, a mouse 812 that selects and executes various commands such as selection of a processing target or movement of the cursor, a Compact Disc Read Only Memory (CD-ROM) drive 814 that controls reading/writing various data from/to a CD-ROM 813 as an example of a removable recording medium, and a bus line 810 such as the address bus or the data bus that electrically connects the above-described components.

<Functional Configuration of Position Management System>

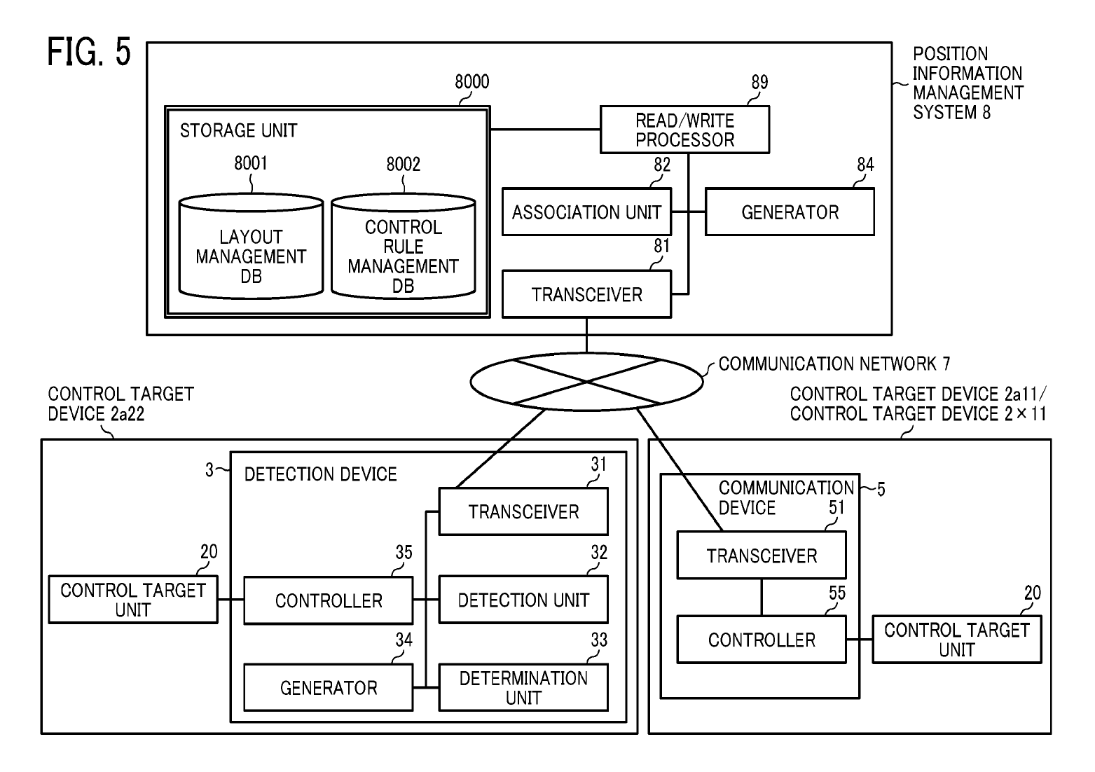

Referring now to FIG. 5, functional configurations of the control target device 2a22 including the detection device 3, the control target device 2a11 (2x), and the position information management system 8 are described according to the embodiment of the present invention. FIG. 5 is a schematic block diagram illustrating the functional configuration of the position management system 1 in this embodiment.

First, the functional configuration of the control target device 2a22 is described below. Those components are functional units that are implemented by operating under commands by the device controller 315 in accordance with the detection control program read from the memory. The control target device 2a22 includes the detection device 3 and a control target unit 20. Furthermore, the detection device 3 includes a transceiver 31, a detection unit 32, a determination unit 33, a generator 34, and a controller 35. In this example where the control target device 2a22 is the LED lighting apparatus, the control target unit 20 is the LED lamp 130 that outputs light under control of the position information management system 8.

The transceiver 31 in the detection device 3 is implemented by the wireless module 301. For example, the transceiver 31 exchanges data with the position information management system 8 via the communication network 2.

The detection unit 32 is implemented by the sensors 311, 312, and 313. For example, the detection unit 32 detects temperature distribution at each area of the partitioned areas in the predetermined space with the temperature distribution sensor 311.

The determination unit 33 is implemented by the sensor driver 304. For example, the determination unit 33 determines whether temperature at each area of the partitioned areas is within a predetermined range (e.g., 30° C. to 35° C.).

The generator 34 is implemented by the sensor driver 304. For example, the generator 34 generates heat source data that indicates existence or nonexistence of a heat source based on the determination result of the determining unit 33.

The controller 35 is implemented by the device controller 315. For example, the controller 35 generates a control signal to be output to the control target unit 20 based on control data transferred by the position information management system 8.

<Functional Configuration of the Control Target Device>

Next, a functional configuration of the control target device 2a11 is described below. The control target device 2a11 includes the communication device 5 and the control target unit 20. Furthermore, the communication device 5 includes a transceiver 51 and a controller 55. In the example case where the control target device 2a11 is the LED lighting apparatus, the control target unit 20 is the LED to be controlled by the position information management system 8. In the example case where the control target device 2x11 is the air conditioner, the control target unit 20 is a compressor etc. of the air conditioner that adjusts temperature, humidity, air flow power, and air flow direction under control of the position information management system 8.

The transceiver 51 in the communication device 5 is implemented by the wireless module 301. Since the transceiver 51 is similar in function to the transceiver 31 described above, its description is omitted.

The controller 55 is implemented by the device controller 315. Since the controller 55 is similar in function to the controller 35 described above, its description is omitted.

<Functional Configuration of Position Information Management System>

Next, a functional configuration of the position information management system 8 is described below. The position information management system 8 includes a transceiver 81, an association unit 82, a generator 84, and a read/write processor 89. Those components are functional units that are implemented by operating under commands by the CPU 801 in accordance with the position information management program read from the RD 804 into the RAM 803. Furthermore, the position information management system 8 includes a storage unit 8000, which may be implemented by the RAM 803 and/or the HD 804 in FIG. 4. The storage unit 8000 stores therein a layout management database (DB) 8001 and a control rule management DB 8002.

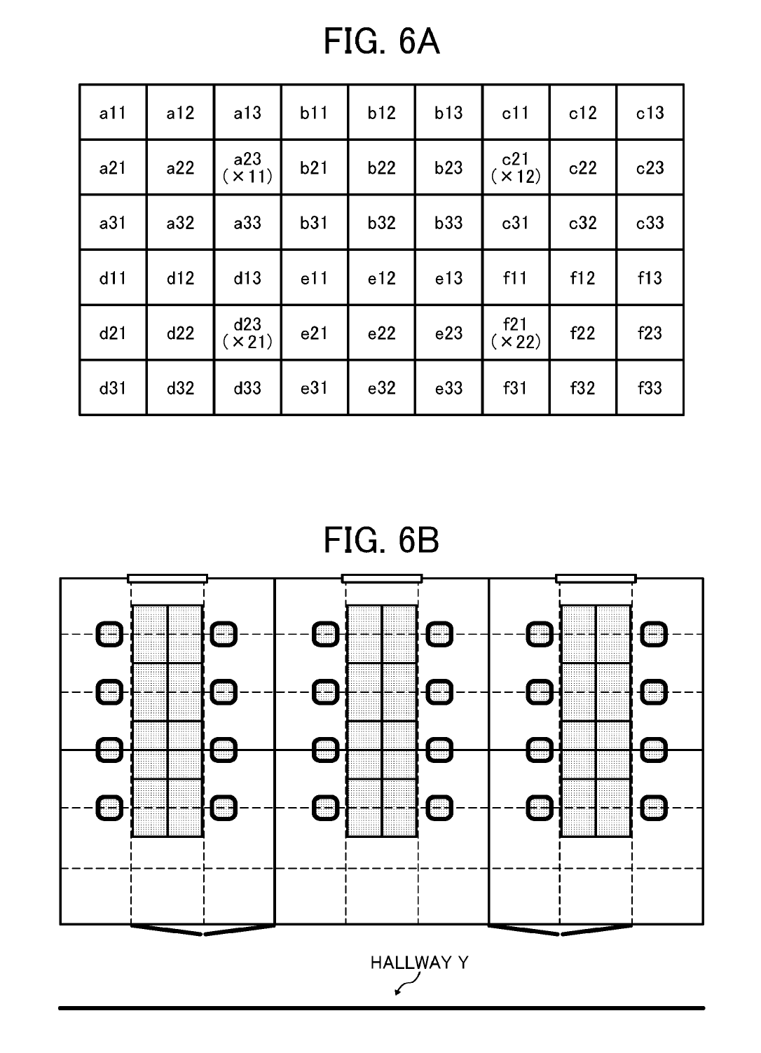

Next, the layout management DB 8001 is described below with reference to FIGS. 6A and 6B. The layout management DB 8001 stores layout information of the control target devices as shown in FIG. 6A. FIG. 6A is a conceptual diagram illustrating layout information of the control target device, and FIG. 6B is a diagram illustrating layout information of the office room. Areas in the layout information in FIG. 6A indicate areas partitioned by broken lines or solid lines on the layout of the office room α shown in FIG. 6B.

As shown in FIG. 6A, in the layout information of the control target devices, the office room α is partitioned into 54 areas. For each partitioned area, a device ID for identifying a specific control target device (such as the LED lighting apparatus) present in that area is assigned. The layout information of FIG. 6A thus manages association between the partitioned area and the device ID in that area. Among these areas, the upper left block whose device IDs start with “a” corresponds to 9 areas in FIG. 1. That is, FIG. 1 illustrates a part of the office room α illustrated in FIGS. 6A and 6B, and the office room α is partitioned into 6 blocks whose device IDs start with a, b, c, d, e, and f, respectively. Furthermore, each of the blocks is partitioned into 9 areas, thus partitioning the office room α into 54 areas in total. The partitioning described above is just an example, and the office room may be partitioned into any desired number of blocks. Similarly, it is possible to partition one block into a number of areas other than nine.

In FIG. 6A, the device IDs x11, x12, x21, and x22 are device IDs for identifying control target devices 2x11, 2x12, 2x21, and 2x22 as the air conditioners. The control target devices 2x12, 2x21, and 2x22 (not shown in FIG. 1) are disposed at respective locations on the ceiling β indicated by x12, x21, and x22 in FIG. 6A. That is, four air conditioners are mounted on the ceiling 13 in the office room α. It should be noted that any one of the control target devices 2x11, 2x12, 2x21, and 2x22 may be referred to as “a control target device 2x” hereinafter.

FIG. 6B illustrates a layout of desks and chairs in the office room α. In FIG. 6B, the office room is partitioned into 54 areas as indicated by the layout information in FIG. 6A. That is, positions of areas in FIG. 6B respectively correspond to positions of areas in FIG. 6A. In FIG. 6B, the lower side indicates a hallway y, and the upper side indicates the window.

(Control Rule Management DB)

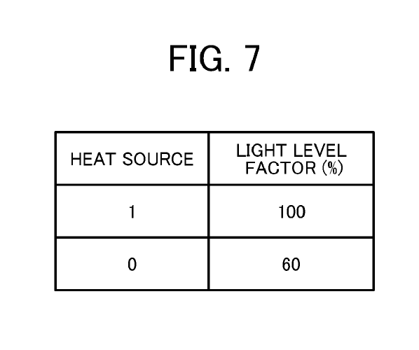

Next, the control rule management DB 8002 is described below with reference to FIG. 7. In the control rule management DB, a control rule management table shown in FIG. 7 is managed. The control rule management table stores, control contents of the control target unit 20 in association with heat source presence information. For example, if the heat source presence information is “1” indicating that the heat source exists, that is, human exists in the area, the light level factor is set at 100% to maximize LED's light level. By contrast, if the heat source presence information is “0” indicating that the heat source does not exist, that is, human does not exist in the area, the light level factor is set at 60% to reduce light level of the LED to save energy. In this case, values 100% and 60% are examples, and any values work as long as the light level factor for the heat source “1” is higher than the light level factor for the heat source “0”, such as values 90% for the heat source “1” and 50% for the heat source “0”.

(Functional Configuration of Position Information Management System)

Next, a functional configuration of the position information management system 8 is described below with reference to FIG. 5, according to the embodiment of the present invention.

The transceiver 81 in FIG. 5 receives detection data from the detection device 3 or transfers control data to the detection device 3.

The association unit 82 refers to layout information in FIG. 6A (described later) and heat source data in FIG. 10 (described later).

The generator 84 generates control data to be transmitted to the control target devices 2a and 2x. For example, the generator 84 generates control data for controlling a light level of the control target device 2a.

The read/write processor 89 reads data from the storage unit 8000 or stores data in the storage unit 8000.

<Operation of the Position Management System>

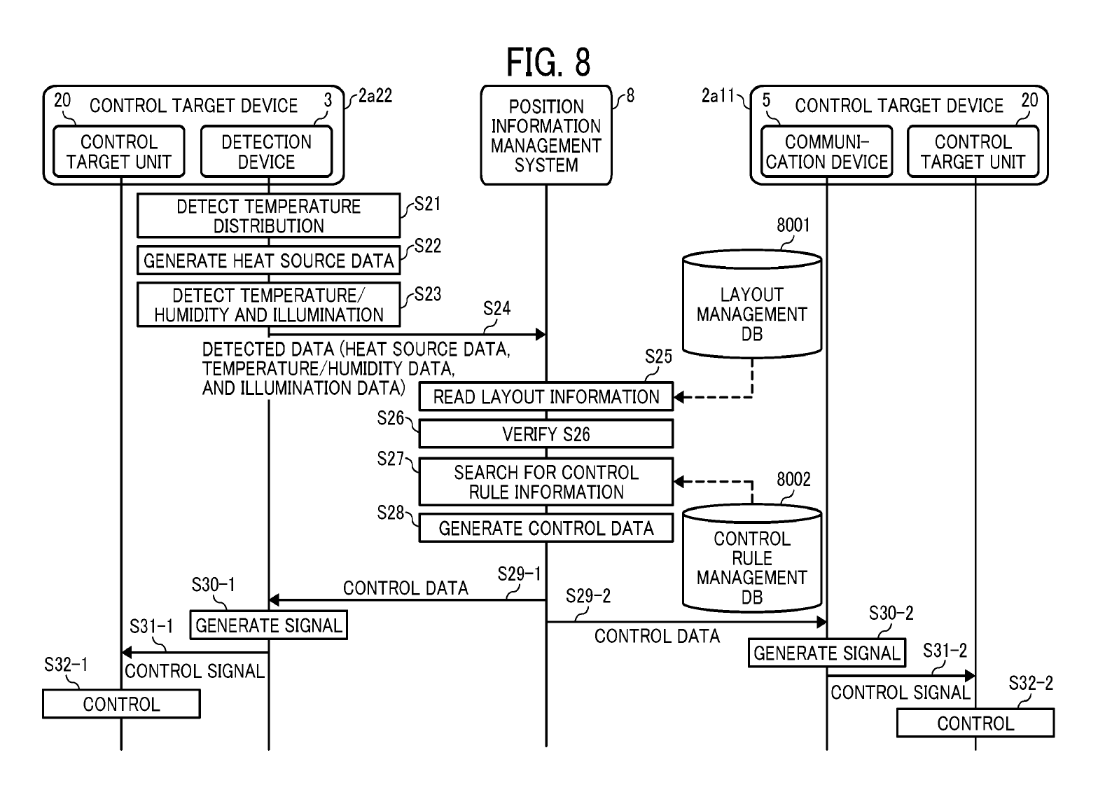

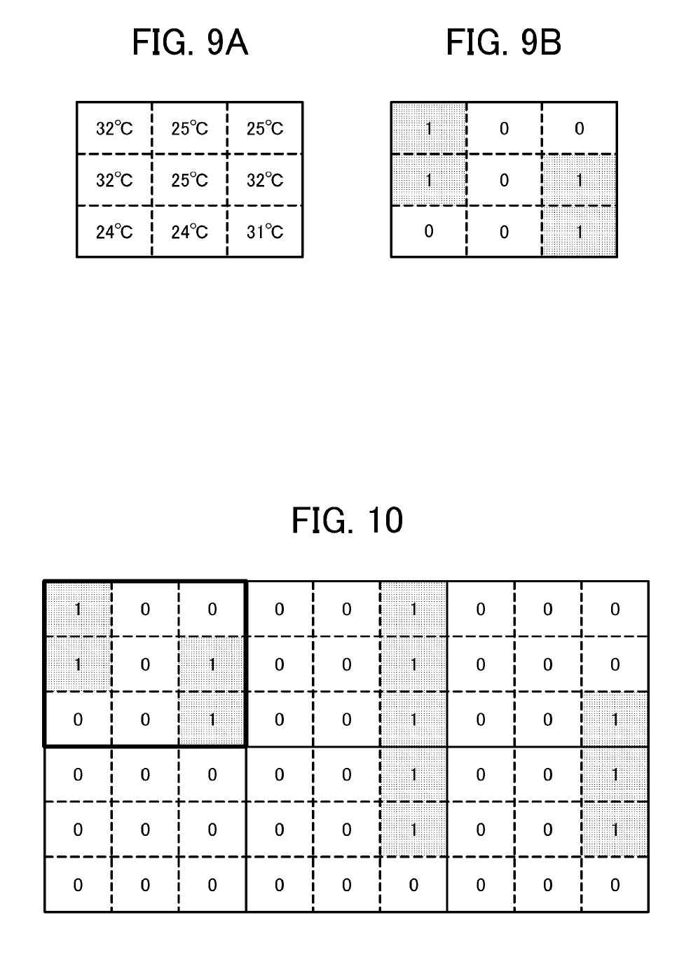

Operation of the position management system is described below with reference to FIGS. 8 to 10. FIG. 8 is a sequence diagram illustrating a process executed by the position management system 1 in this embodiment. FIG. 9A is a conceptual diagram illustrating temperature distribution, and FIG. 9B is a diagram illustrating heat source data that indicates whether a heat source exists. FIG. 10 is a diagram illustrating the heat source data that indicates whether a heat source exists for each area in one office room.

In this example operation, it is assumed that the position information management system 8 generates the control data for controlling the control target devices 2a and 2x based on various data detected by the control target device 2a22 and transfers the control data to the control target devices 2a and 2x to respectively control light level and quantity of air etc. of the control target devices 2a and 2x. To simplify the description, among the control target devices 2a, a process executed by the control target device 2a22 that includes the detection device 3 and the control target device 2a11 that includes the communication device 5 is described below.

First, as illustrated in FIG. 8, the detection unit 32 in the control target device 2a22 detects temperature distribution at each area of a part of the office room α in S21. As described above, the detected part corresponds to the upper left block in FIGS. 6A and 6B. Subsequently, the determination unit 33 determines whether the temperature distribution is within a predetermined range (e.g., 30° C. to 35° C.) for each area, and the generator 34 generates heat source data based on the determination result of the determination unit 33 in S22.

Here, generation of the heat source data is described below with reference to FIGS. 9A and 9B. As the detection unit 32 detects a temperature at each area of nine areas, it is assumed that the temperature distribution of FIG. 9A is obtained. The generator 34 generates heat source data of FIG. 9B based on the temperature distribution of FIG. 9A. That is, the heat source data includes heat source presence information indicating whether the heat source exists. More specifically, an area whose temperature is equal to or more than 30° C. has the value “1” of heat source presence information, and an area whose temperature is less than 30° C. has the value “0” of heat source presence information.

In addition, the detection unit 32 in the control target device 2a22 detects illumination, temperature, and humidity around the control target device 2a22 in S23. Subsequently, the transceiver 31 transfers detection data to the position information management system 8 in S24. The detection data in this example includes the heat source data generated in S22 and the temperature/humidity data and illumination data that indicates the detection result in S23. Accordingly, the transceiver 81 in the position information management system 8 receives the detection data.

FIG. 10 illustrates data that the transceiver 81 integrates the heat source data, which are respectively sent from the detection device 3 provided on the respective blocks of the office room. FIG. 10 is a diagram illustrating the heat source data that indicates whether or not a heat source exists for each area in one office room. For example, the heat source data in FIG. 9B that is received from the detection device 3 of the control target device 2a22 corresponds to the upper left, first block in FIG. 10.

Next, the read/write processor 59 in the position information management system 8 reads the layout information of FIG. 6A from the layout management DB 8001 in S25. Subsequently, the association unit 82 refers to the layout information in FIG. 6A and the heat source data in FIG. 9B in S26 to determine whether the heat source exists in each area. For example, the association unit 82 refers to the location “a11” of the control target device in the layout information and the value “1” of the heat source data, to determine that the heat source exists at the location “a11”.

Next, the read/write processor 59 in the position information management system 8 searches, for each area, the control rule management DB 8002 using “1” or “0” of the heat source data indicating whether the heat source exists as a retrieval key to read corresponding the light level factor in S27. Accordingly, the generator 84 generates control data that indicates the light level factor for each area, to be transmitted to the control target device 2a in each area in S28. More specifically, as illustrated in FIG. 8, the generator 84 generates control data indicating the light level factor to be transmitted to the control target device 2a11. In case of the control target device 2x as the air conditioner, the generator 84 generates control data that indicates, for example, characteristics of air flow for the control target device 2x.

Next, the transceiver 51 transfers each of the control data to the control target devices 2a22 and 2a11 in S29-1 and S29-2, respectively. Subsequently, the transceiver 31 in the detection device 3 in the control target device 2a22 receives the control data. Likewise, the transceiver 51 in the communication device 5 in the control target device 2a11 receives the control data.

Next, in the control target device 2a22, the controller 35 in the detection device 3 generates a control signal to be output to the control target unit 20 as the LED lamp based on the control data received in S30-1 and outputs the control signal to the control target unit 20 in S31-1. As a result, the level of a light to be output from the LED (the control target unit 20) is controlled in S32-1. Similarly, in the control target device 2a11, the controller 55 in the communication device 5 generates a control signal to be output to the control target unit 20 as the LED lamp based on the control data received in S30-2 and outputs the control signal to the control target unit 20 in S31-2. As a result, the level of a light to be output from the LED (the control target unit 20) is controlled in S32-2. For example, referring to FIG. 9B, the area beneath the control target device 2a22 has the value “0” indicating that there is no heat source. Therefore, regarding the control content of the control target device 2a22, the light level factor is set to “60%” in accordance with the rule table of FIG. 7. By contrast, referring to FIG. 9B, the area beneath the control target device 2a11 has the value “1” indicating that there is a heat source. Therefore, regarding the control content of the control target device 2a11, the light level factor is set to “100%” in accordance with the rule table of FIG. 7. Accordingly, if a heat source is detected due to existence of human, the light level of the LED is maximized. If a heat source is not detected due to nonexistence of human, the light level of the LED is reduced. As a result, it is possible to save energy.

The operation of FIG. 8 is performed in a substantially similar manner for the rest of areas in the office room. For example, in case of the control target device 2a as the LED lighting apparatus at other areas in the other blocks, the generator 84 generates control data that indicates each light level factor similarly.

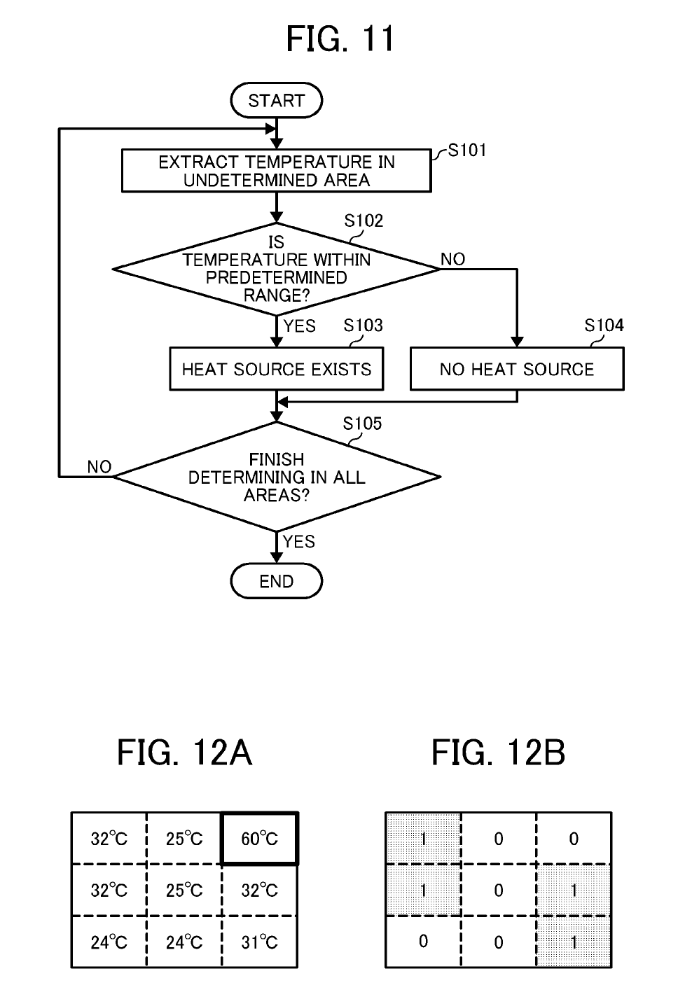

Now, specific examples of the embodiment of the present invention are described below with reference to FIGS. 11 to 17. Here, three examples of generating heat source data in S22 in FIG. 8 are described.

### First Example

The first example is described below with reference to FIGS. 11, 12A and 12B. FIG. 11 is a flowchart illustrating operation of generating the heat source data in this example. FIG. 12A is a conceptual diagram illustrating temperature distribution, and FIG. 12B is a diagram illustrating heat source data that indicates whether a heat source exists.

First, the generator 34 selects an area where the determination unit 33 has not determined whether the temperature is within the predetermined range (e.g., 30° C. to 35° C.) based on the temperature distribution data in S101. Subsequently, the determination unit 33 determines whether or not a temperature at the area selected in S101 is within the predetermined range in S102. For example, if an electrical pot (a water heater) is located at an area where the control target device 2a13 whose device ID is a13 is mounted, as shown in FIG. 12A, it is possible that the temperature at this area becomes 60° C. In this case, even if the heat source exists, the temperature is not within the range of a heat source indicating human (e.g., 30° C. to 35° C.). Therefore, as shown in FIG. 12B, the heat source data is set to “0” indicating that there is no heat source.

In case it is determined that the temperature is within the predetermined range (YES in S102), the operation proceeds to S103 to determine that a heat source exists. By contrast, if the determination unit 33 determines that the temperature is not within the predetermined range (NO in S102), it is determined that there is no heat source in S104. Subsequently, after the determination in S103 and S104, the determination unit 33 determines if the operation of determining whether a temperature is within the predetermined range is complete for all areas in S105. In case of determining that determination is complete for all areas (YES in S105), the process in S22 ends. By contrast, if it is determined that determination is not complete for all areas (NO in S105), the process goes back to S101.

As described above, in this example, even if the heat source exists, if the temperature of the heat source goes beyond a predetermined range reflecting a specific object (e.g., human), it is considered that there is no heat source. This increases accuracy in detecting existence of human. As a result, it is possible to save energy more precisely.

### Second Example

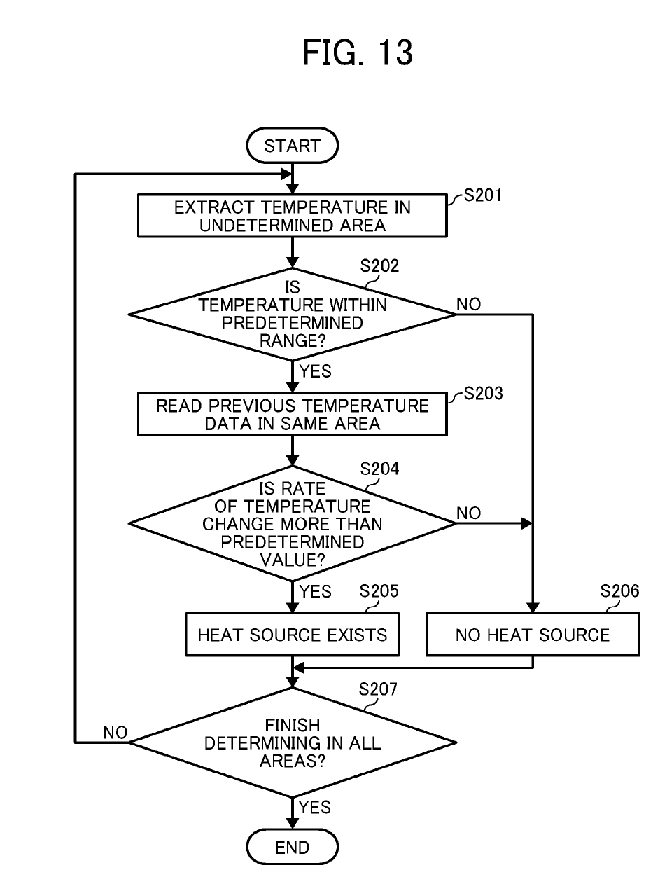

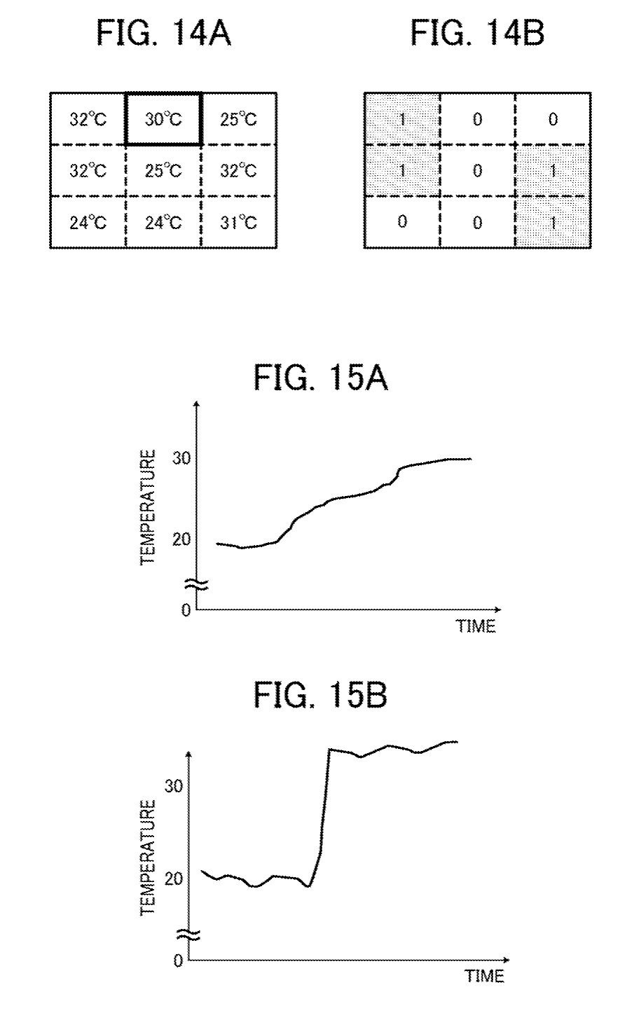

The second example is described below with reference to FIGS. 13 to 15A and 15B. FIG. 13 is a flowchart illustrating operation of generating the heat source data in this example. FIG. 14A is a conceptual diagram illustrating temperature distribution, and FIG. 14B is a diagram illustrating heat source data that indicates whether or not a heat source exists. FIGS. 15A and 15B are graphs illustrating temperature change in a specific area.

In this example, S201, S202, S205, S206, and S207 correspond to S101, S102, S103, S104, and S105 in the first example, respectively. Therefore, steps S203 and S204 are described below. In this example, the sensor driver 304 that implements the detection unit 32 stores in any desired memory detection data of each sensor for a certain period of time (e.g., 10 minutes).

First, if it is determined that the temperature at the specific area is within the predetermined range (YES in S202), the determination unit 33 reads previously detected temperature data for the same specific area from the memory accessible from the detection unit 32 in S203. Subsequently, the determination unit 33 determines whether or not a rate of temperature change at the specific area is more than a predetermined value (e.g., increasing more than 5° C. in ten seconds) in S204. For example, at an area aside of a window where the control target device 2a12 whose device ID is a12 is located, as shown in FIG. 14A, since the temperature is higher compared to those of surrounding areas during daytime, the temperature approaches human temperature. As a result, it is possible to improperly detect as if human exists even though the human does not exist. To cope with this issue, by checking the previously detected temperature, if the temperature rises gradually as shown in FIG. 15A, the determination unit 33 determines that the temperature rises gradually due to not human but sunlight. By contrast, if the temperature rises rapidly as shown in FIG. 15B, the determination unit 33 determines that the temperature rises rapidly since human appeared at the area suddenly, determining that the heat source is derived from the human.

Next, if the determination unit 33 determines that the rate of temperature change is equal to or more than the predetermined value (YES in S204), the determination unit 33 determines that the heat source exists in S205. By contrast, if the determination unit 33 determines that the rate of temperature change is less than the predetermined value (NO in S204), the determination unit 33 determines that the heat source does not exist in S205. As a result, even if the temperature at the specific area is 30° C. as shown in FIG. 14A, the heat source data is set to “0” indicating that the heat source does not exist as shown in FIG. 14B.

As described above, in this example, even if the temperature of the heat source is within the predetermined range that is the same as human temperature, regarding the area where the temperature rises gradually to enter the predetermined range, it is presumed that the area is aside of the window and human does not exist. Therefore, it is considered that there is no heat source at that area, thus detecting human existence precisely. As a result, it is possible to save energy more precisely.

### Third Example

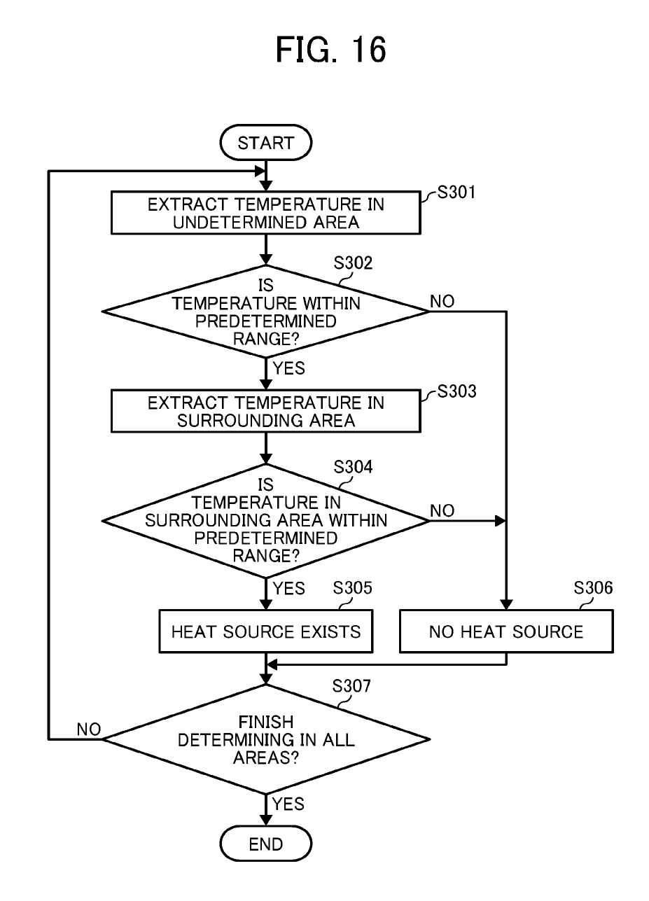

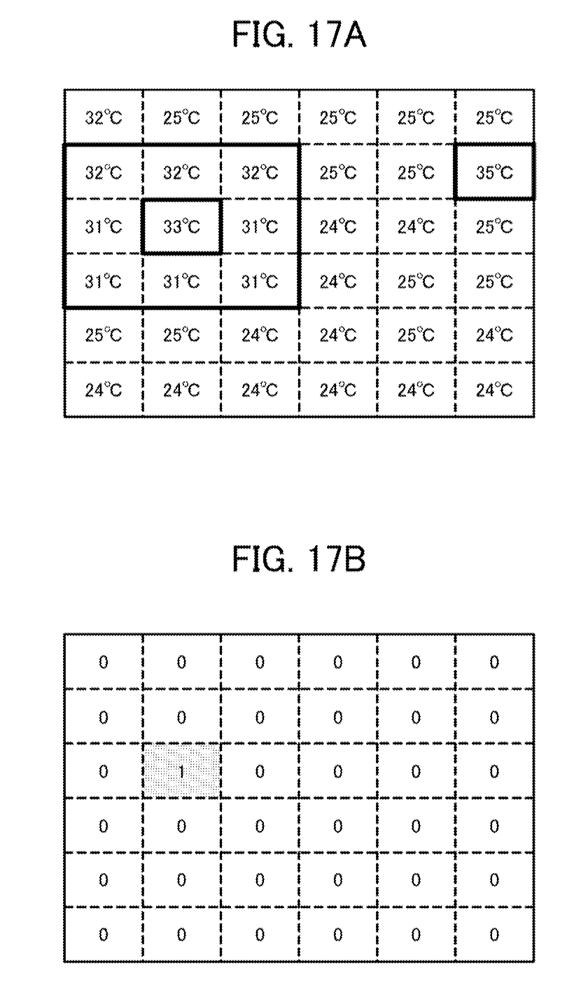

The third example is described below with reference to FIGS. 16, 17A, and 17B. FIG. 16 is a flowchart illustrating operation of generating the heat source data. FIG. 17A is a conceptual diagram illustrating temperature distribution, and FIG. 17B is a diagram illustrating heat source data that indicates whether a heat source exists.

In this example, S301, S302, S305, S306, and S307 correspond to S101, S102, S103, S104, and S105 in the first example respectively. Therefore, steps S303 and S304 are described below. In this example, one block subjected for detection by the detection unit 32 consists of not three-by-three areas in FIGS. 9A and 9B but six-by-six areas. For example, in this example, one area corresponds to a square whose dimensions are 35 cm×35 cm.

First, if it is determined that the temperature at the specific area is within the predetermined range (YES in S302), the determination unit 33 extracts a temperature at areas surrounding the specific area from the temperature distribution data in S303. Subsequently, in S304, the determination unit 33 determines whether or not the temperature at the surrounding area is within the predetermined range as determined in S302. For example, if there is a cup that contains coffee getting cooler in the office room α and its temperature is 35° C. that is around the human temperature, it is possible to improperly detect that human exists even if the human does not actually exist. In this case, while the human does not stay in one area but is astride multiple areas, the cup usually stays in one area. Therefore, by checking the temperature of the surrounding area, if the temperature at the surrounding area is also within the predetermined range, the determination unit 33 determines that the heat source exists. If the temperature at the surrounding area is out of the predetermined range, the determination unit 33 determines that the heat source does not exist. In FIG. 17A, if the specific area at the third row and the second column is 33° C., the determination unit 33 determines that the heat source exists since the temperature values at the surrounding eight areas are also within the predetermined range. By contrast, if the specific area at the second row and the sixth column is 35° C., the determination unit 33 determines that the heat source does not exist since the temperature values at the surrounding five areas are out of the predetermined range. As a result, as shown in FIG. 17B, the specific area at the third row and the second column is set to “1” indicating that the heat source exists, and the specific area at the second row and the sixth column is set to “0” indicating that the heat source does not exist.

Next, if the determination unit 33 determines that the temperature values at the surrounding area are within the predetermined range, the determination unit 33 determines that the heat source exists in S305. By contrast, if the determination unit 33 determines that the temperature values at the surrounding area are out of the predetermined range, the determination unit 33 determines that the heat source does not exist in S305. As a result, even if the temperature at the specific area at the second row and the sixth column is 35° C. as shown in FIG. 17A, the heat source data is set to “0” indicating that the heat source does not exist as shown in FIG. 17B.

As described above, in this example, even if the temperature of the heat source is within the predetermined range that is the same as human temperature, if the range is narrow, it is presumed that the heat source is not human but a small object such as a coffee cup or a pocket stove and the human does not exist. Therefore, it is considered that there is no heat source at the area, thus detecting human existence precisely. As a result, it is possible to save energy more precisely.

Numerous additional modifications and variations are possible in light of the above teachings. It is therefore to be understood that, within the scope of the appended claims, the disclosure of this patent specification may be practiced otherwise than as specifically described herein.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these. The hardware platform includes any desired kind of hardware resources including, for example, a central processing unit (CPU), a random access memory (RAM), and a hard disk drive (HDD). It is also possible to download the program from an external apparatus that includes a storage medium storing the program or stores the program in a storage unit and install the program in the computer to execute the program. The CPU may be implemented by any desired kind of any desired number of processors. The RAM may be implemented by any desired kind of volatile or non-volatile memory. The 1-IDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

1. A detection device, comprising:
a detection unit to detect a temperature at each of multiple areas in a predetermined space where the detection device is provided;
a determination unit to determine whether the detected temperature at each of the multiple areas is within a predetermined range to generate a first determination result;
a generator to generate heat source data indicating that a heat source exists at a specific area of the multiple areas, when the first determination result indicates that the specific area has the detected temperature that is within the predetermined range; and
a transmitter to transmit the heat source data indicating that the heat source exists at the specific area to a management system, wherein the management system controls one or more control target devices provided on the specific area of the predetermined space using the heat source data.

2. The detection device according to claim 1, wherein
the determination unit further determines whether a rate of temperature change for the specific area over a preset time period is equal to or more than a predetermined value to generate a second determination result, and
the generator generates the heat source data indicating that the heat source exists at the specific area when the second determination result determines that the rate of temperature change is equal to or more than the predetermined value in addition to the first determination result indicating that the specific area has the detected temperature within the predetermined range.

3. The detection device according to claim 1, wherein
the determination unit determines whether a temperature at an area surrounding the specific area is within the predetermined range to generate a third determination result, and
the generator generates the heat source data indicating that the heat source exists at the specific area when the third determination result indicates that the temperature at the surrounding area is within the predetermined range in addition to the first determination result indicating that the specific area has the detected temperature within the predetermined range.

4. The detection device according to claim 1, further comprising:
a receiver to receive control data transferred by the management system in response to transmitting the heat source data; and
a controller to control a control target unit based on the received control data.

5. The detection device according to claim 4, wherein the control target unit is a light, and the controller controls a light level of the light based on the control data.

6. The detection device according to claim 5, wherein the light is a LED.

7. The detection device according to claim 1, wherein the detection device and the control target unit are included in a same apparatus.

8. A position management system, comprising:
the detection device according to claim 1; and
a position information management system.

9. A detection method, comprising:
detecting a temperature at each of multiple areas in a predetermined space where the detection device is provided;
determining whether the detected temperature at each of the multiple areas is within a predetermined range to generate a first determination result;
generating heat source data indicating that a heat source exists at a specific area of the multiple areas, when the first determination result indicates that the specific area has the detected temperature that is within the predetermined range; and
transmitting the heat source data indicating that the heat source exists at the specific area to a management system, wherein the management system controls one or more control target devices provided on the specific area of the predetermined space using the heat source data.

10. A non-transitory, computer-readable recording medium storing a program that, when executed by one or more processors, causes the processors to implement a detection method, comprising:
detecting a temperature at each of multiple areas in a predetermined space where the detection device is provided;
determining whether the detected temperature at each of the multiple areas is within a predetermined range to generate a first determination result;
generating heat source data indicating that a heat source exists at a specific area of the multiple areas, when the first determination result indicates that the specific area has the detected temperature that is within the predetermined range; and
transmitting the heat source data indicating that the heat source exists at the specific area to a management system, wherein the management system controls one or more control target devices provided on the specific area of the predetermined space using the heat source data.
